(19) United States
(12) Patent Application Publication
(10) Pub. No.: US 2017/0280746 A1
(43) Pub. Date: Oct. 5, 2017

(54) METHOD FOR PRODUCING FEED OR PET FOOD INGREDIENT USING CRUSHED PINEAPPLE LEAVES AND STALKS AND FEED OR PET FOOD INGREDIENT USING CRUSHED PINEAPPLE LEAVES AND STALKS

(71) Applicant: Chiaki KUSHIDA, Tokyo (JP)

(72) Inventor: Chiaki KUSHIDA, Tokyo (JP)

(21) Appl. No.: 15/625,115

(22) Filed: Jun. 16, 2017

Related U.S. Application Data
(63) Continuation of application No. PCT/JP2016/052333, filed on Jan. 27, 2016.

(30) Foreign Application Priority Data
Apr. 30, 2015 (JP) 2015-093108

(51) Int. Cl. A23K 10/12; A23K 50/45; A23K 30/18; A23K 10/30

(52) U.S. Cl. CPC A23K 10/12; A23K 10/30; A23K 50/45; A23K 30/18

(57) ABSTRACT

Granulated pineapple leaves and stalks dried to correspond to a predetermined fermentation condition are fermented in an anaerobic bacteria fermentative environment in a predetermined room temperature with 15% or more and less than 50% moisture content, or 20 to 40% moisture content maintained therein, to form a pineapple-based feed or pet food ingredient of dryness and low-fermentation condition.

### CROSS REFERENCE TO RELATED APPLICATIONS

This application is a Continuation Application of PCT Application No. PCT/JP2016/052333, filed Jan. 27, 2016 and based upon and claiming the benefit of priority from prior Japanese Patent Application No. 2015-093108, filed Apr. 30, 2015, the entire contents of all of which are incorporated herein by reference.

### BACKGROUND OF THE INVENTION

### 1. Field of the Invention

The present invention relates to a method for producing feed or pet food ingredient using crushed pineapple leaves and stalks, and feed and pet food ingredient produced by the same method.

### 2. Description of the Related Art

Pineapple pulp is an in-factory by-product and is available in the market as livestock feed.

JP2004-215516-A discloses a technique of producing a livestock feed using bagasse, sake lees, and brewer's grain.

JPH11-171676-A discloses a technique related to a compost producing process in which raw garbage is put in a container-type compost maker, the maker is shipped to a target place, and the raw garbage therein is composted during shipment.

Nonaka Kazuhisa et al., “Nutritive Value of Pineapple Process Residue/Soysouce [sic] Cake Mixed Silage”, Hokuchiku Kaihou, Vol. 36, pp. 18-20 discloses a technique of producing a feed mixture by mixing pineapple pulp and soy sauce waste.

JP2004-215516-A does not disclose composting pineapple leaves and stalks.

JPH11-171676-A does not disclose conditions for composting pineapple leaves and stalks.

Animal feeds, especially for cattle, are produced from various ingredients including pineapple pulp. However, the yield of feeds using pineapple pulp alone is poor, and the yield of feeds using other ingredients as disclosed in JP2004-215516-A and Nonaka Kazuhisa et al., “Nutritive Value of Pineapple Process Residue/Soysouce [sic] Cake Mixed Silage”, Hokuchiku Kaihou, Vol. 36, pp. 18-20 is also poor because of a shortage of ingredients; furthermore, the production costs become relatively high.

In countries producing pineapples, such as the Philippines, a large quantity of pineapple leaves and stalks are plowed into the soil of pineapple fields after the harvest of pineapple fruits. Such a large quantity of pineapple leaves and stalks pollutes the soil of the pineapple fields.

In consideration of the above point, the present invention presents a solution of the above problem by producing a livestock feed and a pet food ingredient using a vast quantity of pineapple leaves and stalks after the harvest of pineapple fruits. Pineapple leaves and stalks are rich in sugar and fiber, and thus, if dryness and fermentation conditions are met, they are favorable ingredients for livestock feeds and pet food which are cost effective for dairy farmers and the like.

### BRIEF SUMMARY OF THE INVENTION

The present invention provides a method for producing a pineapple-based feed or pet food ingredient comprising:

separating from a pineapple fruit grown in a pineapple field to a pineapple leaf and a pineapple stalk,

crashing the pineapple leaves and stalks during or after harvest,

drying the crushed pineapple leaves and stalks in a dryer to form dried crushed pineapple leaves and stalks contained moisture,

storing the dried crushed pineapple leaves and stalks with the moisture maintained therein in a moisture-preservative vessel in an anaerobic bacteria fermentative environment, and

continuously fermenting the dried crushed pineapple leaves and stalks with the moisture maintained therein,

wherein the drying process performs a condition which is dried until less than 50% of moisture content,

an ingredient which is the dried crushed pineapple leaves, the dried crushed pineapple stalks, or a mixture thereof is fermented in a predetermined temperature and in the anaerobic bacteria fermentative environment while the moisture is maintained therein, and

a pineapple-based feed or pet food ingredient is formed by way of the dryness and low-fermentation condition which is thrown off smell favored by livestock and pets, the pineapple-based feed or the pet food ingredient being stayed behind smell favored by livestock and pets.

The present invention provides the above method of producing a pineapple-based feed or pet food ingredient, wherein the ingredient is fermented with 15% or more and less than 50% moisture content to be put in the dryness and low-fermentation condition which is thrown off smell favored by livestock and pets.

The present invention provides the above method of producing a pineapple-based feed or pet food ingredient, wherein the ingredient is fermented with 15% or more and less than 50% moisture content to form the low-fermentation condition which is thrown off smell favored by livestock and pets.

The present invention provides the above method of producing a pineapple-based feed or pet food ingredient, wherein the 15% or more and less than 50% moisture content is converted to a 0.176 yield rate or more and less than 0.3 yield rate, or a 0.824 volume reduction or more and less than 0.7 volume reduction, or the 20 to 40% moisture content is converted to a 0.187 to 0.25 yield rate, or a 0.813 to 0.75 volume reduction, and a visually recognizable condition is formed.

The present invention provides the above method of producing a pineapple-based feed or pet food ingredient, wherein the crushed pineapple leaves and stalks are loaded in a ship and are stored, low-fermentation condition thereof is formed during shipment thereof.

The present invention provides a packaged pineapple-based feed or pet food ingredient produced by the above method of producing pineapple-based feed or pet food ingredient.

The present invention provides a pineapple-based feed or pet food ingredient based on an ingredient which is a pineapple leaf, a pineapple stalk, or a mixture thereof, wherein the ingredient has in dryness and is fermented in a predetermined temperature and in an anaerobic bacteria fermentative environment while moisture is contained therein, to form a pineapple-based feed or pet food ingredient, which is stayed behind smell favored by livestock and pets, by way of the dryness and low-fermentation condition which is thrown off smell favored by livestock and pets.

The present invention provides a pineapple-based feed or pet food ingredient based on an ingredient which is a pineapple leaf, a pineapple stalk, or a mixture thereof, wherein the ingredient has in dryness and is fermented in a predetermined temperature and in an anaerobic bacteria fermentative environment while 15 to 50% moisture content or 20 to 40% moisture content is maintained in the ingredient, to form a pineapple-based feed or pet food ingredient, which is stayed behind smell favored by livestock and pets, by way of the dryness and low-fermentation condition which is thrown off smell favored by livestock and pets.

The present invention provides a method for shipping a pineapple-based feed or pet food ingredient packaged in a shipment bag comprising:

separating from a pineapple fruit grown in a pineapple field to a pineapple leaf and a pineapple stalk are,

crushing the pineapple leaves and stalks during or after harvest,

drying the crushed pineapple leaves and stalks in a dryer to form a dryness contained moisture,

packing the dried crushed pineapple leaves and stalks in a vacuum in a moisture-preservative bag for shipping, and

storing the dried crushed pineapple leaves and stalks in the bag with the dryness and the moisture maintained therein to perform fermentation and shipment processes by continuously keeping the storage condition,

wherein an ingredient, which is the dried crushed pineapple leaves, the dried crushed pineapple stalks, or a mixture thereof, has in the dryness and is fermented in a predetermined temperature and in the anaerobic bacteria fermentative environment while 15% or more and less than 50% moisture content is maintained in the ingredient, to form a condition, which is stayed behind smell favored by livestock and pets, by way of the dryness and low-fermentation condition which is thrown off smell favored by livestock and pets, and

a pineapple-based feed or pet food ingredient is sipped out in a condition of the bag which is packaged the pineapple-based feed or pet food ingredient.

According to the present invention, an ingredient which is crushed pineapple leaves, crushed pineapple stalks, or a mixture thereof can be fermented into a low-fermentation condition which appeals to livestock and pets, and using the ingredient, livestock feeds and pet food ingredients which smell sweet corresponding to the fermentation condition can be produced. The present invention solves the above problem by producing the livestock feeds and pet food ingredients using a vast quantity of pineapple leaves and stalks after the harvest of pineapple fruits, which are rich in sugar and fiber. The livestock feeds and pet food ingredients are favored by livestock and pets by adjusting their fermentation condition and are cost effective for dairy farmers and the like.

### BRIEF DESCRIPTION OF THE SEVERAL VIEWS OF THE DRAWING

FIG. 1 shows pineapple plant after harvest of a pineapple fruit.

FIG. 2 shows a comparison of constituents of pineapple pulp, pineapple leaves, and pineapple stalks.

FIG. 3 is a flowchart which shows a method of producing feeds from the pineapple leaves and stalks of an embodiment.

FIG. 4 shows estimated TDN of feeds with varying mixture ratios of a pineapple leaf part and a pineapple stalk part.

FIG. 5 shows an example of a pineapple leaf and stalk harvester.

FIG. 6 shows crushed, granulated pineapple leaves and stalks.

FIG. 7 shows an example of the structure of a dry kiln.

FIG. 8 shows an example of a vacuum-packing bag.

FIG. 9 shows containers including vacuum-packing bags on a ship.

FIG. 10 shows criteria of moisture content and smell in relation to production of pineapple-based feeds in a dry, low-fermentation condition.

### DETAILED DESCRIPTION OF THE INVENTION

The present invention features pineapple leaves and stalks which are sugar-, fiber-, and moisture-rich and naturally contain fermentation bacteria therein. In the present invention, a dryness and low-fermentation of the pineapple leaves and stalks is promoted to meet predetermined fermentation conditions. Conventionally, livestock feeds and pet food ingredients have been produced from various ingredients; however, they have been produced by adding fermentation bacteria to highly moisturized raw ingredients and performing a total fermentation of the bacteria-added ingredients. Through tests conducted by the inventor and other researchers, livestock and pets have been found to favor the sweet smell of fermented pineapple leaves and stalks in a low-fermentation condition and they favorably eat them. Furthermore, the sweet smell of the pineapple-based feeds produced through the low-fermentation condition remains later and is suitable for livestock feeds and pet food ingredients. The livestock feeds and pet food ingredients produced from the pineapple leaves and stalks through such a process to produce a sweet fermentation smell are favored by livestock and pets. Hereinafter, an example of the production of livestock feeds will be explained and the production of pet foods will be analogized. Furthermore, in the present application, a term dry includes a semi-dry condition with some moisture retained therein. Furthermore, in the present application, the term “low-fermentation condition” means a condition that a sweet pineapple smell favored by livestock and pets is thrown off.

The ingredient of the pineapple-based feeds is pineapple leaves, pineapple stalks, or a mixture thereof. As a feature of the present invention, the pineapple-based feeds are produced by way of the low-fermentation condition which is made of sweet smell. Feeds are generally priced on a weight basis, and in a raw condition containing high moisture, the price of the feeds becomes high. The present invention, however, adopts a dryness and low-fermentation condition which reduces such financial burden on dairy farmers caused by buying heavy raw feeds.

The pineapple leaves and stalks contain fermentation bacteria therein and are moisture rich. Using these points, the fermentation of the pineapple leaves and stalks can be performed without adding anaerobic fermentation bacteria such as lactobacilli. However, for an efficient and prompt fermentation process, anaerobic fermentation bacteria such as lactobacilli may be added thereto.

Generally, even if a material is dried to a total dry condition, some moisture remains therein. If a material is dried to have a moisture content of approximately 10%, it is in the total dry condition. If the moisture content is 5% or less, the material becomes charcoal, and fermentation is almost impossible in such a condition. A small quantity of pineapple charcoal may be mixed in the pineapple-based feeds.

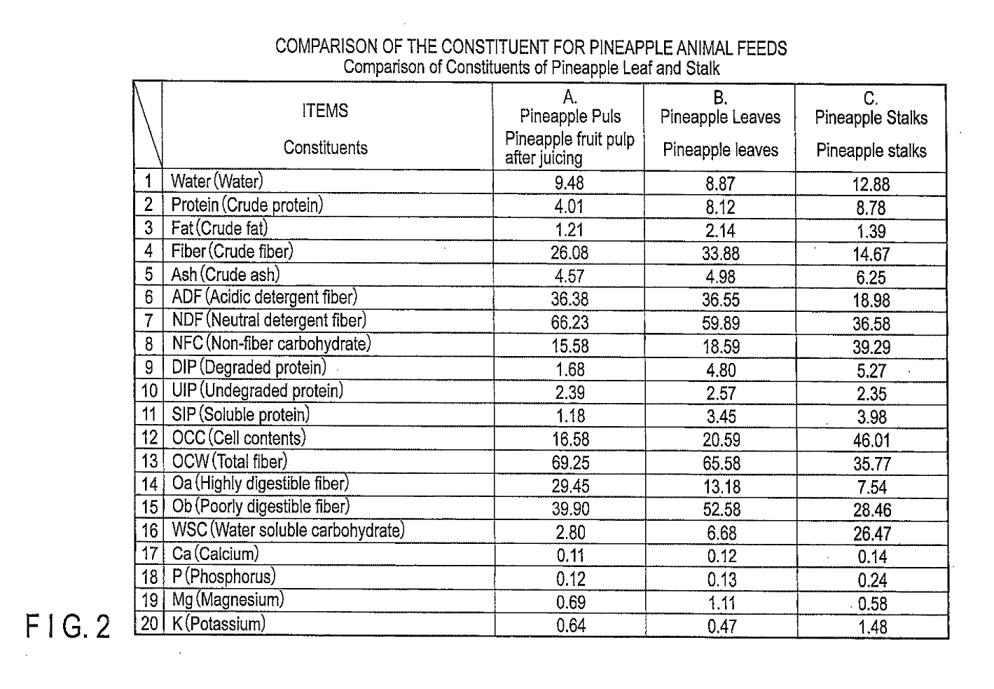

In the present application, the dryness and low-fermentation condition means that the moisture content is kept 15% or more and less than 50%, or preferably, between 20% and 40%. Within such a range, the feeds can be produced to appeal to livestock at a lower cost for the dairy farmers based on the constituents of the pineapple leaves and stalks as shown in FIG. 2. The moisture content can be expressed numerically as a yield rate or a volume reduction.

To achieve the low-fermentation condition through a natural fermentation process, a week or more period of time is required. However, the period can be shortened by adding anaerobic bacteria such as lactobacilli. Even if the period for the natural fermentation process requires a week or more, it still satisfies the needs of the dairy farmers such as appeal to livestock and price as described later.

Dried pineapple leaves and stalks are fermented into a certain condition, and fiber-rich feeds which smell sweet and pleasant to livestock can be produced based on the pineapple leaves and stalks in the dryness and low-fermentation condition. The period required for the fermentation is a week or so, and the fermentation can be completed during the days of shipment of the pineapple leaves and stalks from the country of origin to a destination country such as Japan. The low-fermentation condition can be prepared easily through the days after the harvest in the country of origin. A large quantity of pineapple leaves and stalks acquired in the country of origin are put in the dryness and low-fermentation condition to produce smell favored by livestock, the feeds which appeal to livestock can be achieved immediately in the destination country such as Japan or in the country of origin. The moisture content of the feeds exerts great influence on the price of the feeds. The price of the feeds increases by the moisture content. The present invention is effective to suppress such increase of the price of the feeds for dairy farmers.

Hereinafter, an embodiment will be explained with reference to the accompanying drawings.

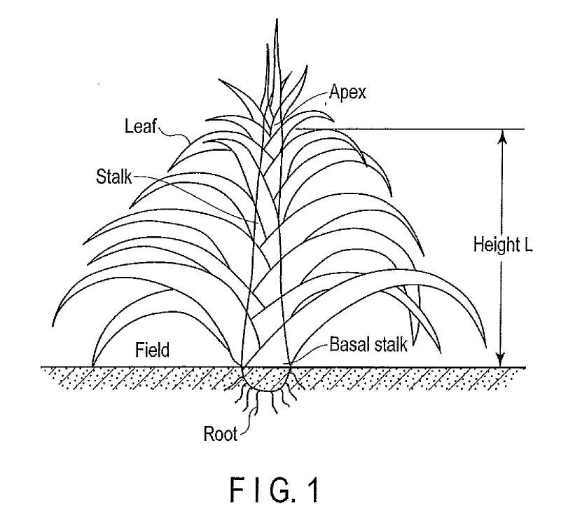

Before explaining the embodiment, characteristics of pineapple leaves and stalks will be explained. FIG. 1 shows pineapple plant after harvest of a pineapple fruit.

As shown in FIG. 1, a pineapple has a stalk growing upward from a root, a plurality of leaves branching from the entire surface of the stalk, the root in the ground, and an apex at the upper end of the stalk. The distance between the ground surface above the root and the axil of the uppermost leaf is referred to as L.

In the present application, a mixture of both pineapple leaves and pineapple stalks will be referred to as pineapple leaf and stalk waste. Pineapple leaves, pineapple stalks, or a mixture thereof can be used as an ingredient of the feeds. The pineapple leaves and stalks contain anaerobic bacterium therein, and when being cut in pieces and left, they are naturally fermented with certain moisture residing therein. Using one of the pineapple leaves, pineapple stalks, and mixture, the feeds required by dairy farmers can be produced. In the embodiment, unless otherwise specified, the mixture of pineapple leaves and stalks is used as the ingredient, and the case where the pineapple leaves or the pineapple stalks are used alone will be analogized.

FIG. 2 shows comparison of constituents of parts of a pineapple.

Pineapple leaves and pineapple stalks have similar characteristics in the items of acidic detergent fiber, neutral detergent fiber, non-fiber carbohydrate, and total fiber, and both are excellent as ingredients of fertilizers and feeds. Comparing the pineapple stalk to the pineapple leaf, the stalk has less total fiber but more non-fiber carbohydrate and organic cell content, and is excellent as an ingredient of feeds. The pineapple leaves and the pineapple stalks are, because of their vast quantity, mixed to be used as an ingredient of mass-produced livestock feeds. Comparing to feeds based on pineapple pulps and widely-used feeds made from dried grasses, the production cost becomes cheaper. Furthermore, by harvesting the vast quantity of pineapple leaves and stalks, acidification of the pineapple field can be prevented, and sustainable production of pineapples can be achieved.

As explained above, the pineapple leaf is fiber-rich and thus is used as roughage. Pineapple stalks are nutritious and thus are used as concentrated feed. The pineapple leaves and stalks are constitutionally similar to the pineapple pulp and are excellent as livestock feeds. The roughage and the concentrated feed can separately be produced and traded, and can be mixed in an optional ratio as pineapple-based feeds. The pineapple-based feeds may be mixed with other feeds to adjust the amount of fiber therein.

Pineapple leaves and stalks left in a pineapple field after harvest belong to the farm owner in most cases. To solve the wastage problem caused by the pineapple leaves and stalks left in the pineapple field, the embodiment provides a pineapple-based feed produced through a fermentation process utilizing the characteristics of pineapple leaves and stalks. The pineapple leaves and stalks are constitutionally similar to the pineapple pulp, that is, excellent as livestock feeds, and they are dried in a low-fermentation condition in a short period, that is, cost effective. Thus, using pineapple leaves and stalks is advantageous to farm owners.

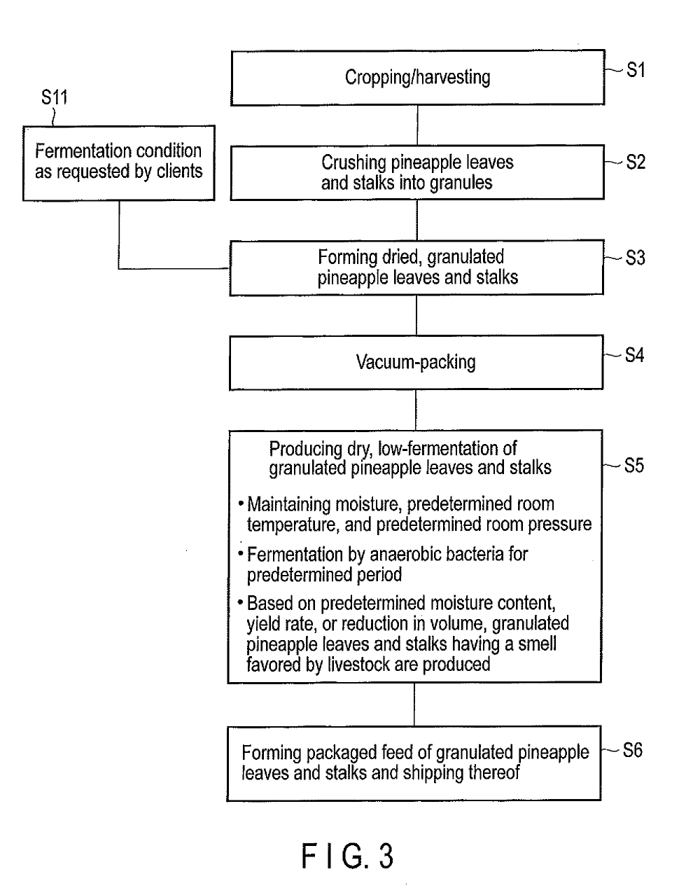

FIG. 3 is a flowchart showing a method of producing feeds from pineapple leaves and stalks of the embodiment.

The method of producing feeds from pineapple leaves and stalks of FIG. 3 includes the following steps (S1) to (S6).

The method includes:

harvesting pineapple leaves and stalks after harvesting pineapple fruits in a pineapple field (S1);

crushing the pineapple leaves and stalks during or after the harvesting to form crushed pineapple leaves and stalks (or granulated pineapple leaves and stalks) (S2);

drying the granulated pineapple leaves and stalks in a dryer to form dried, granulated pineapple leaves and stalks (S3);

vacuum-packing the dried, granulated pineapple leaves and stalks in bags for shipping (S4);

promoting a dryness and low-fermentation of the granulated pineapple leaves and stalks (S5); and

forming and shipped out a packaged feed based on the granulated pineapple leaves and stalks (S6).

In step (S3), the degree of dryness may be determined based on the low-fermentation condition required by a client using the data thereof in a PS (S11); however, no limitation is intended thereby. In many cases, the pineapple farmers may determine the low-fermentation condition. Or, the low-fermentation condition may be determined empirically. In either case, the low-fermentation condition is determined to be associated with the degree of dryness.

In step (S4), as in step (S3), the dried, granulated pineapple leaves and stalks are put in a moisture-preservative vessel in an anaerobic bacterium fermentation environment to be fermented to a predetermined extent and the low-fermentation condition is maintained.

In step (S5), the moisture of granulated pineapple leaves and stalks is maintained in a vacuum-packed manner without adding water thereto, and the dryness and low-fermentation thereof is promoted by fermentation bacteria such as anaerobic lactobacilli added thereto in a predetermined room temperature and a predetermined room pressure, or the dryness and low-fermentation thereof may be promoted by a natural semi-fermentation process by anaerobic bacteria in, for example, a week or more. Through the above steps, the granulated pineapple leaves and stalks in the dryness and low-fermentation condition are produced with a moisture content, yield rate, or volume reduction satisfying a predetermined moisture content, or its equivalent yield rate or volume reduction.

In step (S6), after the granulated pineapple leaves and stalks in the dryness and low-fermentation condition are produced with a moisture content, yield rate, or volume reduction satisfying a predetermined moisture content, or its equivalent yield rate or volume reduction, packaged feeds made of the granulated pineapple leaves and stalks in the dryness and low-fermentation condition are prepared and shipped.

A temperature increases during fermentation, and thus, the low fermentation can be achieved sufficiently at a room temperature; however, it may be carried out at a slightly high room temperature.

The above steps include harvesting pineapple leaves and stalks after harvesting pineapple fruits in a pineapple field, crushing the pineapple leaves and stalks during or after the harvesting, drying the crushed pineapple leaves and stalks in a dryer to form dried, crushed pineapple leaves and stalks with moisture contained therein, packing the dried pineapple leaves and stalks in a moisture-retaining bag for shipping in a vacuum-packed manner, and maintaining the aforementioned condition, wherein, in the dryness condition, a fermentation condition is set for a predetermined period of time. Or, the fermentation condition may be set preliminarily.

Specifically, an ingredient which is the pineapple leaves, the pineapple stalks, or a mixture thereof is fermented in an anaerobic bacteria fermentative environment in a predetermined temperature with 15% or more and less than 50% moisture content maintained therein, to form a pineapple-based feed, which r stays behind smell favored by livestock, by way of the dryness and low-fermentation condition which is thrown off smell favored by livestock.

The ingredient is fermented in the anaerobic bacteria fermentative environment in a predetermined temperature with 20 to 40% moisture content maintained therein such that the ingredient is put in a dryness and low-fermentation condition which smells pleasant to livestock, and the pineapple-based feed is produced thereby.

The granulated pineapple leaves and stalks are vacuum-packed with certain moisture contained therein, and are dried and fermented in the anaerobic bacterium fermentative environment in a predetermined room temperature, wherein the fermentation is kept in the low-fermentation condition. The granulated pineapple leaves and stalks fermented into the dryness and low-fermentation condition are packaged for shipment.

Through the above steps, the granulated pineapple leaves and stalks in the dryness and low-fermentation condition are packed in a bag for shipment, and the feeds based on the granulated pineapple leaves and stalks in the dryness and low-fermentation condition are produced.

The livestock feeds may be produced from the pineapple leaves and stalks using the above method in the country of origin, or may be produced during the shipment. When the livestock feeds are unloaded in a destination country such as Japan, they are immediately sent to contracting dairy farmers with the low-fermentation condition of the livestock feeds maintained as demanded.

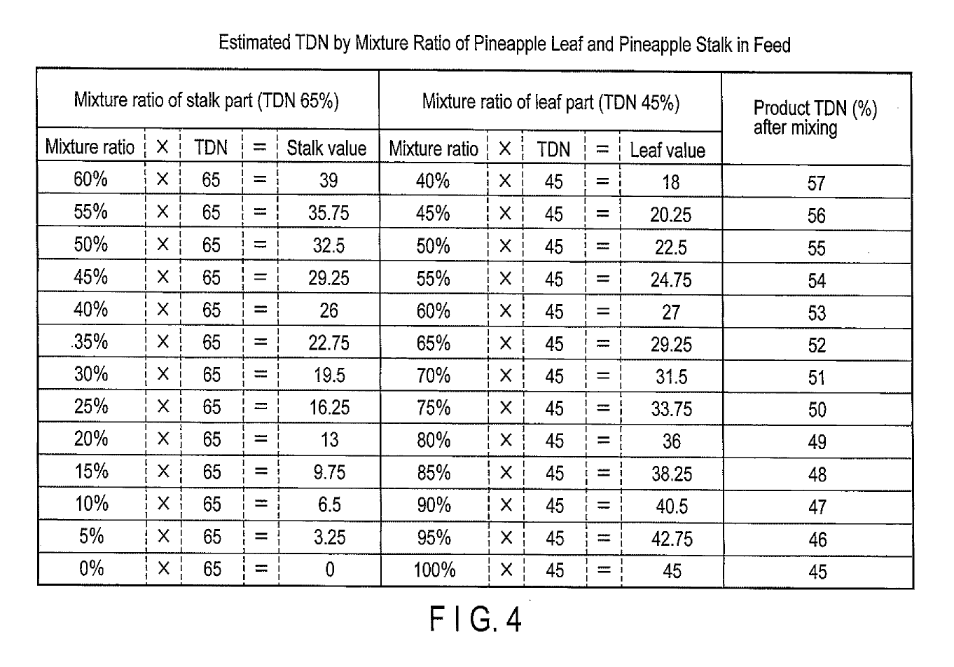

FIG. 4 is a table which shows estimated total digestible nutrients (TDN) % (Standard Tables of Feed Composition in Japan) of the pineapple-based feed with varying mixture ratios between the leaf and the stalk. In the table, the stalk part (estimated TDN is 65%), the leaf part (estimated TDN 45%), and the mixture product TDN % are shown in this order on the x-axis while varying mixture ratios are shown on the y-axis. The mixture product TDN % is very high in each case. Even if the stalk part is 0%, the product TDN % indicates a high value. TDN % of rice straw-based feed has been found to be approximately 37% and its nutrition is sufficient. When the leaf part and the stalk part are mixed fifty-fifty, TDN of the pineapple-based feed reaches 55%, which is higher than that of straw feeds. Since the pineapple leaf part is fiber-rich, the pineapple-based feeds produced as a mixture of the leaves and the stalks become fiber-rich and highly nutritious. In a raw condition, the stalk part will be 20 to 30%; however, the mixture product TDN is still 49 to 51% which is high and favorable as livestock feeds.

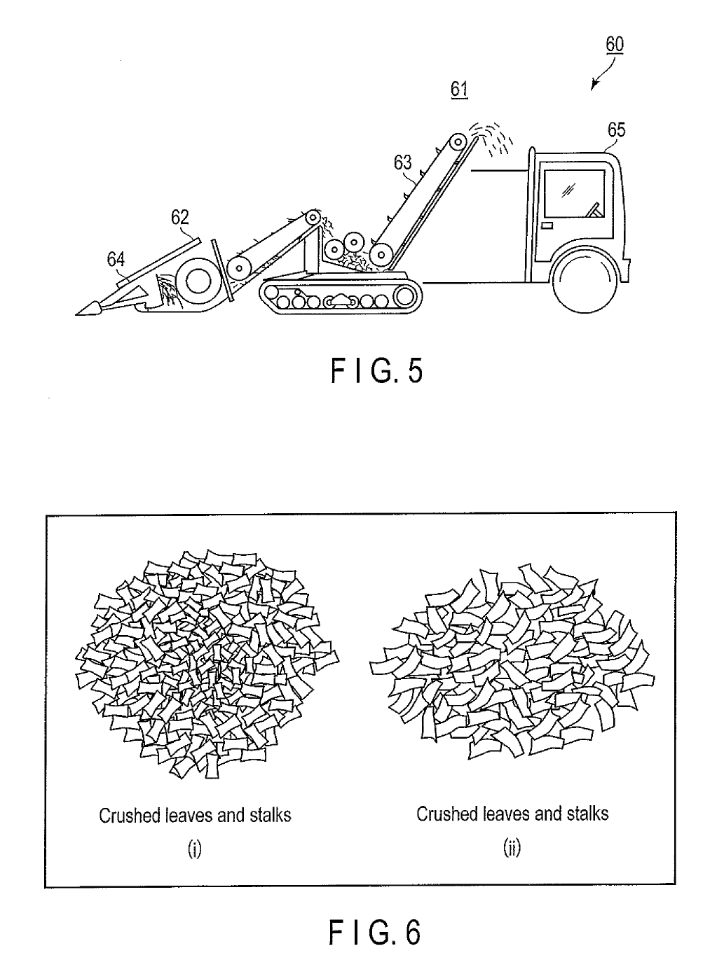

FIG. 5 shows a pineapple leaf and stalk harvester (61) used in the harvesting of the pineapple leaves and stalks (S1) in a pineapple leaf and stalk harvesting system (60) after harvesting pineapple fruits from pineapple plants in a pineapple field.

As shown in FIG. 5, the harvester (61) includes a cutter (64), crusher (62), and conveyor (63). The cutter (64) includes a cutting blade the angle of which can be adjusted vertically at its tip. The harvester (61) is automotive and can harvest several lines of pineapple leaves and stalks at the same time. The harvested pineapple leaves and stalks are crushed, and the crushed pineapple leaves and stalks are conveyed by a conveyor belt of the conveyor (63) to be loaded in a track (65).

FIG. 6 shows granulated pineapple leaves and stalks formed through the step of crushing the pineapple leaves and stalks during or after the harvesting (S2).

In FIG. 6, item (i) shows granulated pineapple leaves and stalks cut finely and item (ii) shows granulated pineapple leaves and stalks cut relatively roughly.

To promote the fermentation, the grain size should be smaller. In general, if the grain size is larger, a drying process of the grains needs a longer period.

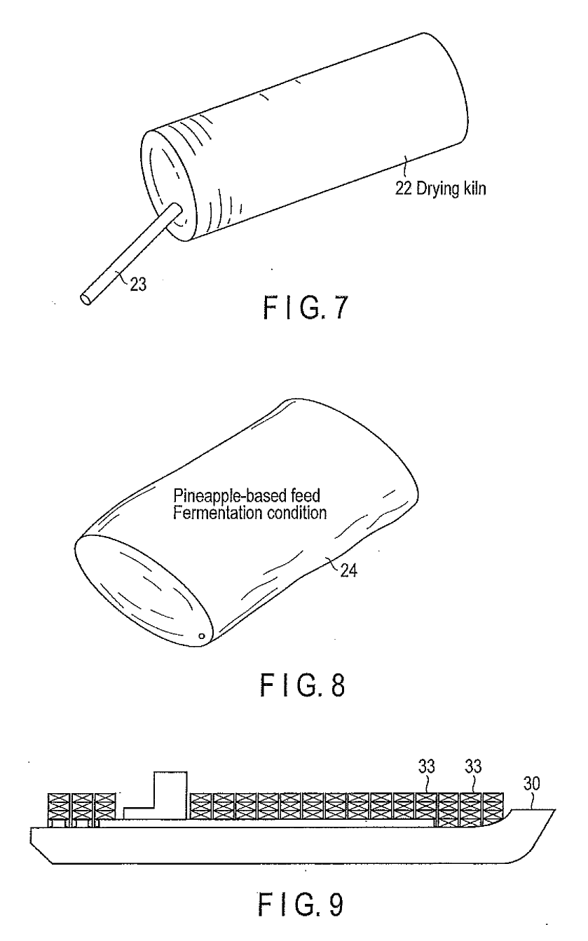

FIG. 7 shows a drying process of the granulated pineapple leaves and stalks in which the grains are put in the dryer, that is, a drying kiln (22) and dried by heated air introduced therein through an air tube (23). As above, pineapple leaves and stalks are harvested after harvesting pineapple fruits in a pineapple field, crushed during or after the harvesting process, and dried in the dryer to form dried, granulated pineapple leaves and stalks with certain moisture contained therein.

FIG. 8 shows the dried, granulated pineapple leaves and stalks vacuum-packed in a shipment bag (24). Instead of the bag (24), other packages may be adopted. A notification of the low-fermentation condition as requested by clients is recommended to be put on the surface of the bag (24) or to be kept in a database or the like. The data may be input in a personal computer and confirmed on a screen.

The granulated pineapple leaves and stalks are fermented therein by anaerobic bacteria naturally contained in the grains in a predetermined room temperature for a predetermined period of time, for example, a week or more. The grains are put in the low-fermentation condition in which low-fermentation continues. Thereby, the dried and vacuum-packed granulated pineapple leaves and stalks become the pineapple granulated leaf and stalk feeds in the dryness and low-fermentation condition.

As shown in FIG. 9, the low fermentation corresponding to the preliminarily set dry condition may be promoted during the shipment of the bags. The fermentation of the granulated pineapple leaves and stalks by anaerobic bacteria naturally contained therein is promoted in the bags loaded in the ship heading to the destination country, and using the shipment period, the granulated pineapple leaf and stalk feeds in the dryness and low-fermentation condition are produced. Alternatively, the granulated pineapple leaves and stalks may be fermented in a warehouse.

As an example, the production of the granulated pineapple leaf and stalk feeds in the dryness and low-fermentation condition may be performed by promoting the low fermentation of the crushed, granulated pineapple leaves and stalks produced in the country of origin in a ship.

The pineapple leaves and stalks are fully fermentative in a room temperature and a room pressure after the crush even without an assistance of a fermentation accelerator such as lactobacilli. If a fermentation accelerator such as lactobacilli is added, the fermentation is promoted deliberately and the process can be performed smoothly.

To promote the fermentation, sufficient moisture is maintained in the granulated pineapple leaves and stalks in the dryness and low-fermentation condition. Because of their rich sugar content, the granulated pineapple leaves and stalks can be fermented by anaerobic bacteria even with relatively low moisture content. Therefore, the fermentation can be continued until the low fermentation is completed in an anaerobic condition. As mentioned above, anaerobic bacteria may be added.

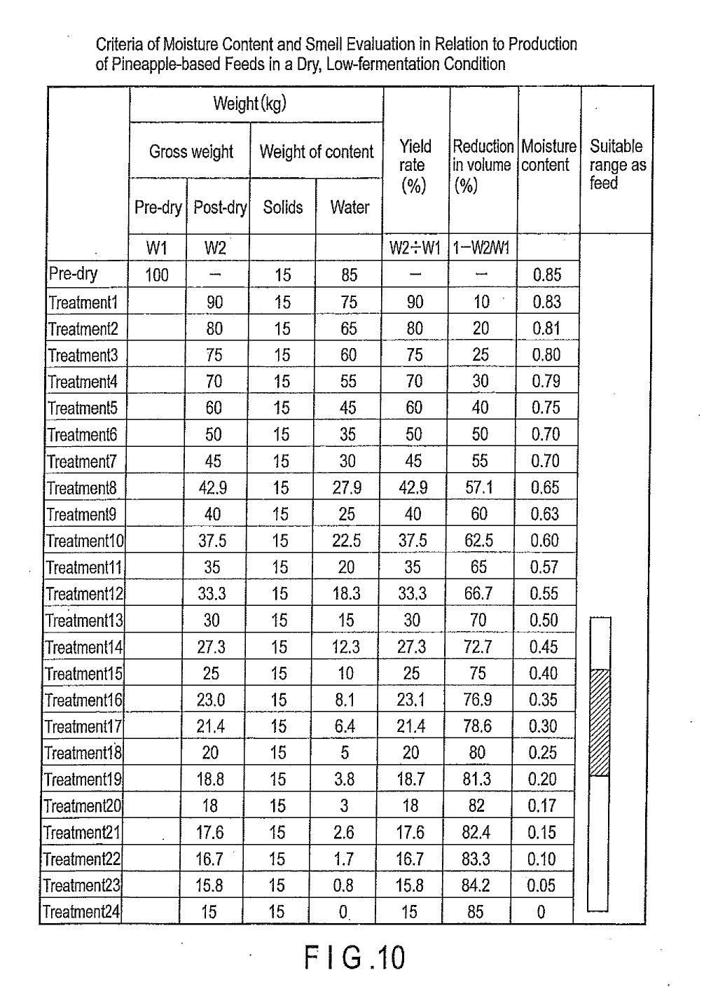

FIG. 10 shows a table which explains criteria of moisture content and smell in relation to the pineapple-based feed in a dryness and low-fermentation condition.

In the table of FIG. 10, items such as pre-dry moisture content, pre-dry weight (W1), post-dry weight

(W2), yield rate (W2/W1), volume reduction (1−W2/W1), moisture content X, smell evaluation (suitability as feed), price (buying cost), and suitable range as feed.

The data in the table were measured after the fermentation process. The weight is the sum of solid substance and moisture in a typical pineapple. The moisture content is calculated by moisture amount/total weight and represented by %. In general, the solid substance is 16% and the moisture is 84% in a pineapple, and the pre-dry moisture content is 84%. However, in many cases, the solid substance is slightly less, and thus, in this example, the solid substance is set 15% and the pre-dry moisture content is set 85%. In this case, even if the pineapple is dried completely, 15% of the solid substance does not decrease.

Livestock tend to eat feeds with smell and the smell is caused by the moisture content of the feeds. In general, the granulated pineapple leaf and stalk feeds are priced based not on the amount of solid substance but on the gross weight. The nutrient depends on the amount of solid substance in the total weight of the feeds, and if the volume reduction is low and the moisture content is high, the price of the feeds becomes high although the nutrient becomes low. If the dryness of the feeds becomes high, both the total weight and the price decrease. That is, the drier feeds are favored by farmers but not by livestock. Therefore, when producing feeds, the following contradictory condition must be considered: feeds having higher volume reduction are favored by farmers but not by livestock. Feeds preferably chosen by livestock tend to be expensive. Therefore, feed sellers must consider decreasing the production cost of pineapple granulated leaf and stalk feeds and also increasing preference of the feeds by livestock. Considering the above, going out door the granulated pineapple leaf and stalk feeds in a dryness and low-fermentation condition of the embodiment is an important proposal.

Now, a formula used for production of feeds in the dryness and low-fermentation condition will be explained.

1) As a precondition, weight W1 of raw ingredient pineapple leaves and stalks before a drying process is measured.

2) Moisture content of raw ingredient pineapple leaves and stalks is given, as mentioned above, 85% (0.85).

a) After the drying process of the raw ingredient, moisture content X is derived by:

X=[0.85−(1−W2/W1)]/(W2/W1)

where pre-dry moisture content is 0.85, pre-dry weight is W1, and post-dry weight is W2.

Therein, W2/W1 is yield rate and (1-W2/W1) is volume reduction.

Therefore, X=(0.85−volume reduction)/yield rate.

For example, if 100 kg of granulated pineapple leaves and stalks are dried to yield 20 kg, moisture content X is calculated as:

$$\begin{matrix}X = [ 0.85 - ( 1 - 20 \text{/} 100 ) ] \text{/} ( 20 \text{/} 100 ) \\ = ( 0.85 - 0.8 ) \text{/} 0.2 \\ = 0.25\end{matrix}$$

Therefore, moisture content is 25%.

b) Yield rate Y is determined to reduce the weight of the raw ingredient to have the moisture content therein correspond to moisture content X which is requested by clients. To determine yield rate Y, the following formula is used.

$$\begin{matrix}Y = ( 1 - 0.85 ) \text{/} ( 1 - X ) \\ = ( 1 - 0.85 ) \text{/} ( 1 - 0.25 ) \\ = 0.2\end{matrix}$$

Therefore, yield rate is 0.2 and volume reduction is 0.8.

The above formulae are used in a scene where the degree of fermentation is confirmed. The degree of fermentation varies based on the moisture content, and is confirmed numerically using the yield rate or the volume reduction based on the formula of b). The adjustment of moisture content is thus easily performed, and the feeds can be produced to meet the degree of fermentation required by clients.

Even after the feeds are produced based on the formula of b), the moisture content in the feeds continues to vary depending on storage and distribution conditions. Thus, based on the formula of a), the amount of water in the feeds is calculated to be optimal when the feeds are handed to clients or served to livestock.

FIG. 10 shows treatments 1 to 24 of the production process. In treatment 1, dryness is weak in the early treatment of the process and the amount of water is thus 75 kg. That is, the moisture content is 83%. Therein the yield rate is 0.9 and the volume reduction is 0.1 (10%) and the weight is 90 kg.

The process proceeds as treatments 1 to 24 in FIG. 10.

Now, a suitable range as the feed will be explained. To determine a suitable range as the feed, the smell of the feed was used as a criterion.

In treatment 1, no fermentation smell was detected.

In treatments 2 to 9, the fermentation of the pineapple leaves and stalks was in progress; however, a rotting-like odor was recognized because of the high moisture content therein. Livestock do not like such a rotting-like odor, and thus, feeds in these treatments are not favorable.

In treatments 10 to 12, a smell like a chemical agent was recognized in the fermentation smell. Livestock do not like such a chemical agent-like smell, either.

In treatments 1 to 12, the moisture content was 0.83 to 0.55, the yield rate was 0.9 to 0.333, and the volume reduction was 0.1 to 0.667.

Feeds in treatments 13 to 24 are thus adopted for further consideration.

In treatments 22 to 24, the moisture content of the pineapple leaves and stalks was low and the dryness therein became complete, and the smell of the substances, that is, the smell of the pineapple leaves and stalks was recognized in the fermentation smell. In treatment 24, the moisture content of the feeds was 0% and the feeds were charred. Thus, the feeds in treatments 22 to 24 as they are will not be favored by livestock due to the absence of moisture; however, they may be served to livestock as a mixture to the feeds in treatments 13 to 21. If the dryness of the feeds in treatments 22 to 24 is determined to be suitable as livestock feeds, the feeds may be given to livestock with water added thereto.

In treatments 13 to 24, the moisture content was 0.1 to 0, the yield rate was 0.167 to 0.15, and the volume reduction was 0.833 to 0.85. Note that the moisture content of 0% is very difficult to achieve.

In treatments 13 to 21, the pineapple leaves and stalks are thrown off a sweet fermentation smell which is favored by livestock. Since livestock like the sweet smell, the feeds of treatments 13 to 21 are suitable. The production cost and the price can be decreased by using the feeds of treatments 13 to 21. If the volume reduction is low as in the feeds of treatments 1 to 12, the price increases and are not favored by dairy farmers. If the volume reduction is high, the price decreases as favored by dairy farmers; however, the cost for after treatment increases. Considering the above, feeds of treatments 13 to 21, and especially of treatments 15 to 19 are suitable.

In treatments 13 to 21, the moisture content was 0.5 to 0.15, the yield rate was 0.3 to 0.1764, and the volume reduction was 0.7 to 0.824.

The feeds of treatments 15 to 19 were actually served to livestock and favored thereby. In treatments 15 to 19, the moisture content was 0.4 to 0.2, the yield rate was 0.25 to 0.187, and the volume reduction was 0.75 to 0.813.

The pineapple granulated dried to correspond to a predetermined fermentation condition are fermented in an anaerobic bacteria fermentative environment in a predetermined room temperature with 15% or more and less than 50% moisture content maintained therein such that the packaged feeds based on pineapple leaves and stalks in the dryness and low-fermentation condition are produced.

Now, the production cost of the feeds based on the granulated pineapple leaves and stalks within the suitable range will be considered. As shown in FIG. 10, the feeds in the low-fermentation condition with 20 to 40% moisture content can be produced at low cost. From this point, the feeds in the low-fermentation condition with 20 to 40% moisture content are suitable as feeds.

The above values are changed and adjusted within the suitable range for the low-fermentation condition to correspond to the request of client. The low-fermentation process can be promoted in a shipment bag which can maintain the moisture content therein in a vacuum-packed manner. Since the feeds produced based on the granulated pineapple leaves and stalks in the dryness and low-fermentation condition are packed and shipped out, the nutritional value of the feeds is maintained while the production cost is reduced.

No additional treatment is required for the feed produced as above; however, a different livestock feed may be added thereto. The crushed, granulated pineapple leaves and stalks are put in a natural anaerobic condition for a long period and are fermented into a low-fermentation condition which is thrown off sweet smell favored by livestock. The sweet smell indicates the suitability of the feed. In the present embodiment, such a condition may be referred to as a dryness and low-fermentation condition of granulated pineapple leaves and stalks which keeps an anaerobic fermentation smell and which is served to livestock without an additional treatment.

According to the present Example, a method for shipping of a feed made of granulated pineapple leaves and stalks in a dryness and low-fermentation condition is provided. In the method, the volume reduction of pineapple leaves and stalks is predetermined, and the dryness is determined based on the moisture content, yield rate, and reduction in volume. The granulated pineapple leaves and stalks are dried for a predetermined period and vacuum-packed to maintain the moisture therein, and are fermented in a predetermined room temperature by anaerobic bacteria naturally contained in the granulated pineapple leaves and stalks or by an anaerobic fermentation accelerator added thereto. The feed made of granulated pineapple leaves and stalks in the dryness and low-fermentation condition is formed and packaged for shipping. Therein, the fermentation of the feed by anaerobic bacteria is promoted in a vacuum-packed manner.

According to the present Example, using the contents shown in FIG. 2, the granulated pineapple leaves and stalks are dried to correspond to a desired fermentation condition and fermented into a low-fermentation condition which is thrown off smell favored by livestock, and a livestock feed which is thrown off sweet smell corresponding to the low-fermentation condition is produced. Thereby, the above mentioned problem is solved, and livestock feeds made of a vast quantity of pineapple leaves and stalks left after the harvest of pineapple fruits can be produced. Since the pineapple leaves and stalks are sugar-and fiber-rich, and are favored by livestock by adjusting the fermentation condition thereof. Furthermore, the produced feeds are cost effective for dairy farmers.

What is claimed is:

1. A method for producing a pineapple-based feed or pet food ingredient comprising:
separating from a pineapple fruit grown in a pineapple field to a pineapple leaf and a pineapple stalk,
crashing the pineapple leaves and stalks during or after harvest,
drying the crushed pineapple leaves and stalks in a dryer to form dried crushed pineapple leaves and stalks contained moisture,
storing the dried crushed pineapple leaves and stalks with the moisture maintained therein in a moisture-preservative vessel in an anaerobic bacteria fermentative environment, and
continuously fermenting the dried crushed pineapple leaves and stalks with the moisture maintained therein,
Wherein the drying process performs a condition which is dried until less than 50% of moisture content,
an ingredient which is the dried crushed pineapple leaves, the dried crushed pineapple stalks, or a mixture thereof is fermented in a predetermined temperature and in the anaerobic bacteria fermentative environment while the moisture is maintained therein, and
a pineapple-based feed or pet food ingredient is formed by way of the dryness and low-fermentation condition which is thrown off smell favored by livestock and pets, the pineapple-based feed or the pet food ingredient being stayed behind smell favored by livestock and pets.

2. The method of claim 1, wherein the ingredient is fermented with moisture content of 15% or more and less than 50% to form the low-fermentation condition which is thrown off smell favored by livestock and pets.

3. The method of claim 1, wherein the ingredient is fermented with 20 to 40% moisture content in the predetermined temperature and in the anaerobic bacteria fermentative environment to form the low-fermentation condition which is thrown off smell favored by livestock and pets.

4. The method of claim 2 or 3, wherein the 15% or more and less than 50% moisture content is converted to a 0.176 to 0.3 yield rate or a 0.824 to 0.7 volume reduction, or the 20 to 40% moisture content is converted to a 0.187 to 0.25 yield rate or a 0.813 to 0.75 volume reduction.

5. The method of claim 1, wherein the crushed pineapple leaves and stalks are loaded in a ship, and low-fermentation condition thereof is formed during shipment and keeping thereof.

6. A pineapple-based feed or pet food ingredient which is produced from an ingredient of pineapple leaves, pineapple stalks, or a mixture thereof in dryness, wherein the dryness is a condition which is dried until less than 50% of moisture content and anaerobic smell which appeals to livestock and pets is produced.

7. The pineapple-based feed or pet food ingredient of claim 6, wherein the dryness is 15% or more and less than 50% of the moisture content.

8. The pineapple-based feed or pet food ingredient of claim 6, wherein the dryness is 20 to 40% of the moisture content.

9. A method for shipping a pineapple-based feed or pet food ingredient packaged in a shipment bag comprising:
separating from a pineapple fruit grown in a pineapple field to a pineapple leaf and a pineapple stalk are,
crushing the pineapple leaves and stalks during or after harvest,
drying the crushed pineapple leaves and stalks in a dryer to form a dry condition in which dried crushed pineapple leaves and stalks contain moisture,
packing the dried crushed pineapple leaves and stalks in a vacuum in a moisture-preservative bag for shipping, and
storing the dried crushed pineapple leaves and stalks in the bag with the dryness and the moisture maintained therein to perform fermentation and shipment processes by continuously keeping the storage condition,
wherein an ingredient, which is the dried crushed pineapple leaves, the dried crushed pineapple stalks, or a mixture thereof, has in the dryness and is fermented in a predetermined temperature and in the anaerobic bacteria fermentative environment while 15% or more and less than 50% moisture content is maintained in the ingredient, to form a condition, which is stayed behind smell favored by livestock and pets, by way of the dryness and low-fermentation condition which is thrown off smell favored by livestock and pets, and
a pineapple-based feed or pet food ingredient is sipped out in a condition of the bag which is packaged the pineapple-based feed or pet food ingredient.

10. The method of claim 9, wherein the ingredient is fermented in a predetermined temperature and in the anaerobic bacteria fermentative environment while 20 to 40% moisture content is maintained in the ingredient.
